(19) United States
(12) Patent Application Publication
(10) Pub. No.: US 2013/0086024 A1
(43) Pub. Date: Apr. 4, 2013

(54) Query Reformulation Using Post-Execution Results Analysis

(71) Applicants: Yi Liu, Beijing (CN); Yu Chen, Beijing (CN); Qing Yu, Beijing (CN); Ji-Rong Wen, Beijing (CN)

(72) Inventors: Yi Liu, Beijing (CN); Yu Chen, Beijing (CN); Qing Yu, Beijing (CN); Ji-Rong Wen, Beijing (CN)

(73) Assignee: MICROSOFT CORPORATION, Redmond, WA (US)

(21) Appl. No.: 13/248,894

(22) Filed: Sep. 29, 2011

(51) Int. Cl. G06F 17/30

(52) U.S. Cl. 707/706; 707/728; 707/E17.136

(57) ABSTRACT

Systems, methods, devices, and media are described to facilitate the training and employing of a three-class classifier for post-execution search query reformulation. In some embodiments, the classification is trained through a supervised learning process, based on a training set of queries mined from a query log. Query reformulation candidates are determined for each query in the training set, and searches are performed using each reformulation candidate and the un-reformulated training query. The resulting documents lists are analyzed to determine ranking and topic drift features, and to calculate a quality classification. The features and classification for each reformulation candidate are used to train the classifier in an offline mode. In some embodiments, the classifier is employed in an online mode to dynamically perform query reformulation on user-submitted queries.

### BACKGROUND

As the amount of information available to users on the web has increased, it has become advantageous to find faster and more efficient ways to search the web. Automatic search query reformulation is one method used by search engines to improve search result relevance and consequently increase user satisfaction. In general, query reformulation techniques automatically reformulate a user's query to a more suitable form, to retrieve more relevant web documents. This reformulation may include expanding, substituting, and/or deleting from the original query one or more terms to produce more relevant results.

Many traditional query reformulation techniques focus on determining a reformulated query that is semantically similar to the original query, by mining search logs, the corpus of pages on the web, or other sources. Many such methods rely on pre-execution analysis, and attempt to predict, prior to execution, whether a reformulated query will produce an improved result. However, it is often the case that a semantically similar, reformulated query generated through pre-execution analysis is not effective to improve search result relevance. For example, reformulated queries are often susceptible to topic drift which occurs when the query is reformulated to such an extent that it is directed to a different topic than that of the original query.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly described, the embodiments presented herein enable search query reformulation based on a post-execution analysis of potential query reformulation candidates. The post-execution analysis employs a classifier (e.g. a classifying mathematical model) that distinguishes beneficial query reformation candidates (e.g. those candidates that are likely to improve search results) from query reformation candidates that are less beneficial or not beneficial. In some embodiments, the classifier is trained via machine learning. This machine learning may be supervised machine learning, using a technique such as a decision tree method or support vector machine (SVM) method. In some embodiments, the classifier training takes place in an offline mode, and the trained classifier is then employed in an online mode to dynamically process user search queries.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1 is a pictorial diagram of an example user interface for a search engine.

FIG. 2 is a schematic diagram depicting an example environment in which embodiments may operate.

FIG. 3 is a diagram of an example computing device (e.g. client device) that may be deployed as part of the example environment of FIG. 2.

FIG. 4 is a diagram of an example computing device (e.g. server device) that may be deployed as part of the example environment of FIG. 2.

FIGS. 5A and 5B depict a flow diagram of an illustrative process for training a classifier for query reformulation, in accordance with embodiments.

FIGS. 6A and 6B depict a flow diagram of an illustrative process for employing a classifier for query reformulation of online queries, in accordance with embodiments.

### DETAILED DESCRIPTION

### Overview

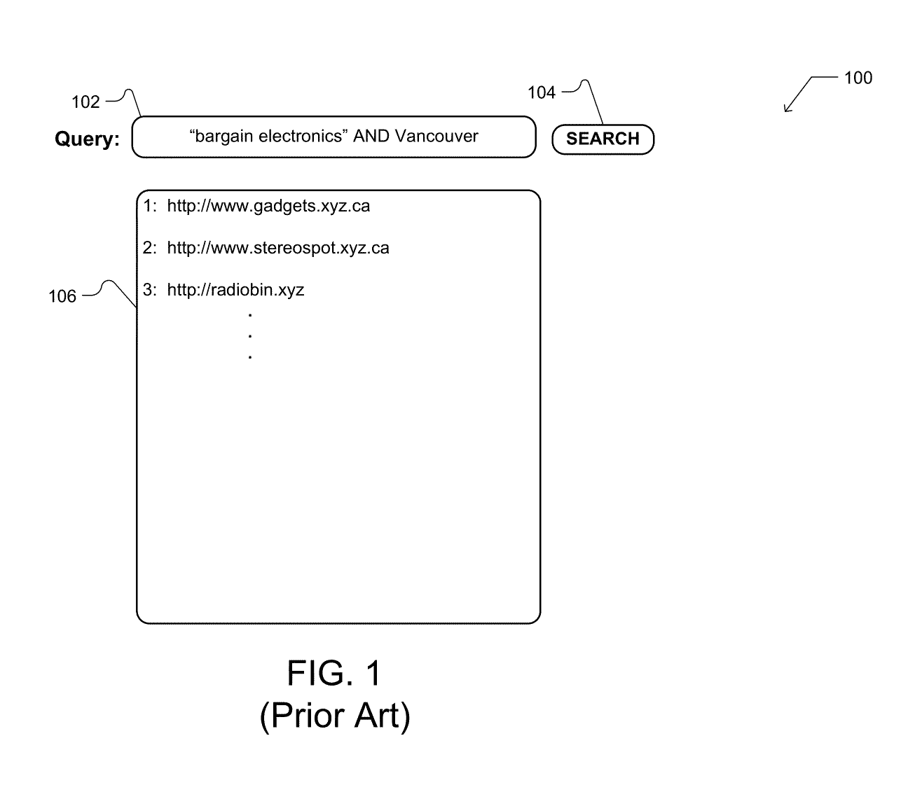

Embodiments described herein facilitate the training and/or employing of a multi-class (e.g. three-class) classifier for post-execution query reformulation. Various embodiments operate within the context of an online search engine employed by web users to perform searches for web documents. An example web search service user interface (UI) 100 is depicted in FIG. 1.

As shown, the search interface 100 may include a UI element such as query input text box 102, to allow a user to input a search query. In general, a search query may include a combination of search terms of multiple words (e.g. “bargain electronics”) and/or individual words (e.g. “Vancouver”), combined using logical operators (e.g., AND, OR, NOT, XOR, and the like). Having entered a query, the user may employ a control such as search button 104 to instruct the search engine to perform the search. Search results may then be presented to the user as a ranked list in display 106. The search results may be presented along with brief summaries and/or excerpts of the resulting web documents, images from the resulting documents, and/or other information such as advertisements.

Generally, query reformulation takes place automatically behind the scenes in a manner that is invisible to the user. That is, the search engine may automatically reformulate the user's query, search based on the reformulated query, and provide the search results to the user without the user knowing that the original query has been reformulated.

Embodiments include methods, systems, devices, and media for search query reformulation based on a post-execution analysis of potential query reformulation candidates. Embodiments described herein include the evaluation of query reformulation candidates to determine those candidates that will provide improved (e.g. more relevant) search results when incorporated into an original query. In some embodiments, a query reformulation candidate is a triple that includes three values: 1) the original query; 2) a term from the original query; and 3) a substitute term that is a suitable substitute for the term. Examples of possible substitute terms include, but are not limited to, replacing a singular word with its plural (or vice versa), replacing an acronym with its meaning (or vice versa), replacing a term with its synonym, replacing a brand name with a generic term, and so forth.

Some embodiments include the training and/or employment of a classifier (e.g. a classifying mathematical model) to evaluate query reformulation candidates. In some embodiments, the classifier is trained using machine learning. For example, the classifier may be trained using a supervised machine learning method (e.g. decision tree or SVM). Training the classifier may take place in an offline mode, and the trained classifier may then be employed in an online mode, to dynamically process and reformulate incoming user search queries received at a search engine.

Offline classifier training may begin with the identification of a set of one or more training queries to use in training the classifier. The training queries may be selected from a log of search queries previously made by users of a search engine. This selection may be random, or by some other method. For each query in the training set, one or more query reformulation candidates may be generated. In some embodiments, the query reformulation candidates may be filtered prior to subsequent processing, to increase efficiency of the process as described further herein.

In some embodiments, a search is then performed using each of the query reformulation candidates, to retrieve a set of web documents for each candidate. Further, a search may also be performed using each of the queries in the training set. These searches may be performed using a search engine. Then, for each query in the training set, a comparison may then be made between the set of web documents resulting from a search on the training set query and each set of web documents resulting from a search using each query reformulation candidate. Such comparison will determine whether each query reformulation candidate produces more relevant search results than the corresponding un-reformulated training set query.

In some embodiments, two different analyses may be performed when comparing search results from the reformulation candidate to the results from the un-reformulated training query. As a first analysis, a set of features may be extracted that provide a comparison of the two sets of search results. In some embodiments, these features include two types of features: ranking features and topic drift features. Ranking features provide evidence that the reformulated query provides improved results in that more relevant documents are generally ranked higher in the search results. Topic drift features provide evidence that the reformulation is causing topic drift relative to the un-reformulated query. Both types of features are described in more detail herein.

As a second analysis, a quality score is computed for each query reformulation candidate. The quality score provides an indication of the relative quality of the reformulation candidate compared to the un-reformulated training query. The quality score may indicate that the reformulation candidate will produce an improved result, a worse result, or a substantially similar (or the same) result as the un-reformulated query. In this way, candidates are classified into a positive, negative, or neutral category respectively based on whether the results are improved, worse, or substantially similar (or the same). The results of these two analyses (i.e., the extracted features and the quality score) are then used to train the classifier.

In an example implementation, a three-class classifier evaluates reformulation candidates based on a three-class model. In some embodiments, the classifier is a mathematical model or set of mathematical methods that, once trained, can be stored and used to process and reformulate online queries received at a search engine.

The online reformulation process proceeds similarly to the offline training process, but with certain differences. After receiving a user query submitted online to a search engine by a web user, one or more query reformulation candidates may be generated for that original query. A search may then be performed for each of the reformulation candidates, and the results may be compared to the results of a search based on the original query. Through this comparison, a set of features may be extracted. As in the offline process, features may include ranking features and topic drift features. These feature sets may then be provided to the classifier, enabling the classifier to classify each query reformulation candidate as positive, negative, or neutral.

The search engine may then employ this classification to determine whether to incorporate the reformulation candidate into a reformulated query. In some embodiments, the reformulated query may be a combination of the original query and one or more reformulation candidates determined by the classifier to produce an improved search result. The search engine may then search using the reformulated query, and provide the search results to the user. The offline and online modes of operation are described in greater detail below.

### Illustrative Environment

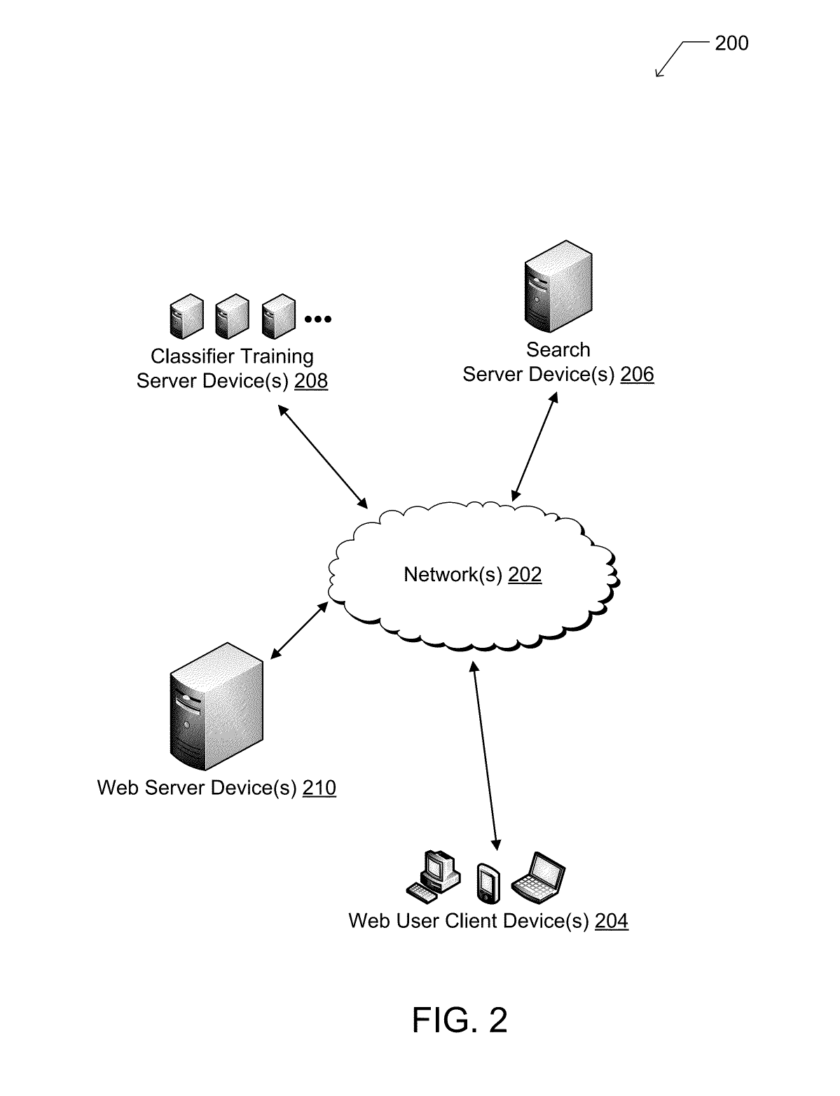

FIG. 2 shows an example environment 200 in which embodiments of QUERY REFORMULATION USING POST-EXECUTION RESULTS ANALYSIS operate. As shown, the various devices of environment 200 communicate with one another via one or more networks 202 that may include any type of networks that enable such communication. For example, networks 202 may include public networks such as the Internet, private networks such as an institutional and/or personal intranet, or some combination of private and public networks. Networks 202 may also include any type of wired and/or wireless network, including but not limited to local area networks (LANs), wide area networks (WANs), Wi-Fi, WiMax, and mobile communications networks (e.g. 3G, 4G, and so forth). Networks 202 may utilize communications protocols, including packet-based and/or datagram-based protocols such as internet protocol (IP), transmission control protocol (TCP), user datagram protocol (UDP), or other types of protocols. Moreover, networks 202 may also include a number of devices that facilitate network communications and/or form a hardware basis for the networks, such as switches, routers, gateways, access points, firewalls, base stations, repeaters, backbone devices, and the like.

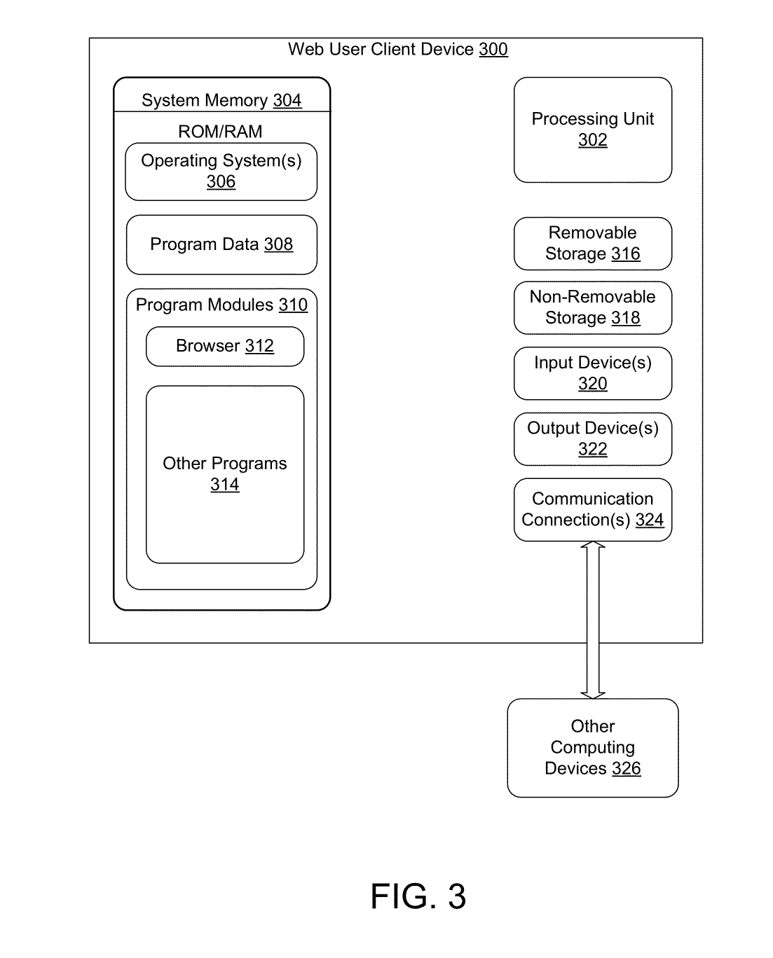

Environment 200 further includes one or more web user client device(s) 204 associated with web user(s). Briefly described, web user client device(s) 204 may include any type of computing device that a web user may employ to send and receive information over networks 202. For example, web user client device(s) 204 may include, but are not limited to, desktop computers, laptop computers, pad computers, wearable computers, media players, automotive computers, mobile computing devices, smart phones, personal data assistants (PDAs), game consoles, mobile gaming devices, set-top boxes, and the like. Web user client device(s) 204 generally include one or more applications that enable a user to send and receive information over the web and/or Internet, including but not limited to web browsers, e-mail client applications, chat or instant messaging (IM) clients, and other applications. Web user client devices 204 are described in further detail below, with regard to FIG. 3.

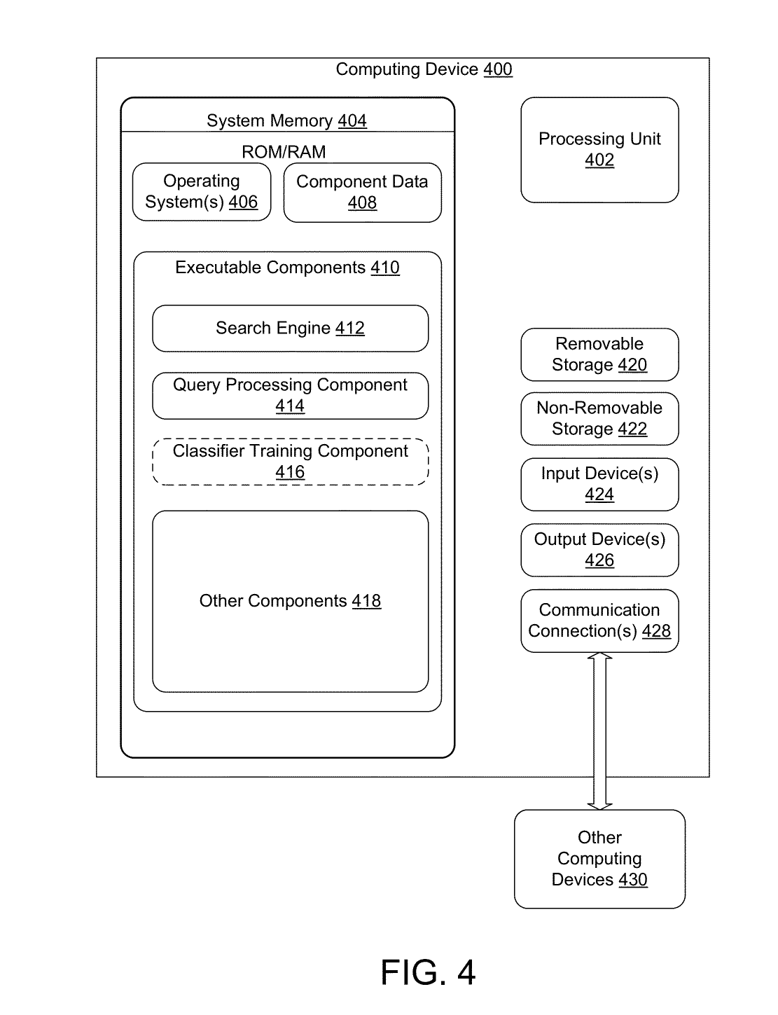

As further shown FIG. 2, environment 200 may include one or more search server device(s) 206. Search server device(s) 206, as well as the other types of server devices shown in FIG. 2, are described in greater detail herein with regard to FIG. 4. Search server device(s) 206 may be configured to operate in an online mode to receive web search queries entered by users, such as through a web search user interface as depicted in FIG. 1. Search server device(s) 206 may be further configured to perform dynamic query reformulation as described further herein, perform a search based on raw and/or reformulated queries, and/or provide search results to a user. In some embodiments, query reformulation may be performed by a separate server device in communication with search server device(s) 206.

As described herein, online query reformulation may employ a classifier that is trained offline. In some embodiments, the classifier is trained using one or more server devices such as classifier training server device(s) 208. In some embodiments, the classifier training server device(s) 208 are configured to create and/or maintain the classifier. In some embodiments, the classifier is developed using machine learning techniques that may include a supervised learning technique (e.g., decision tree or SVM). However, other types of machine learning may be employed. As depicted in FIG. 2, the classifier training server device(s) 208 may be configured as a cluster of servers that share the various tasks related to training the classifier, through load balancing, failover, or various other server clustering techniques.

As shown, environment 200 may further include one or more web server device(s) 210. Briefly stated, web server device(s) 210 include computing devices that are configured to serve content or provide services to users over network(s) 202. Such content and services include, but are not limited to, hosted static and/or dynamic web pages, social network services, e-mail services, chat services, games, multimedia, and any other type of content, service or information provided over the web.

In some embodiments, web server device(s) 210 may collect and/or store information related to online user behavior as users interact with web content and/or services. For example, web server device(s) 210 may collect and store data for search queries specified by users using a search engine to search for content on the web. Moreover, web server device(s) 210 may also collect and store data related to web pages that the user has viewed or interacted with, the web pages identified using an IP address, uniform resource locator (URL), uniform resource identifier (URI), or other identifying information. This stored data may include web browsing history, cached web content, cookies, and the like.

In some embodiments, users may be given the option to opt out of having their online user behavior data collected, in accordance with a data privacy policy implemented on one or more of web server device(s) 210, or on some other device. Such opting out allows the user to specify that no online user behavior data is collected regarding the user, or that a subset of the behavior data is collected for the user. In some embodiments, a user preference to opt out may be stored on a web server device, or indicated through information saved on the user's web user client device (e.g. through a cookie or other means). Moreover, some embodiments may support an optin privacy model, in which online user behavior data for a user is not collected unless the user explicitly consents.

Although not explicitly depicted, environment 200 may further include one or more databases or other storage devices, configured to store data related to the various operations described herein. Such storage devices may be incorporated into one or more of the servers depicted, or may be external storage devices separate from but in communication with one or more of the servers. For example, historical search query data (e.g., query logs) may be stored in a database by search server device(s) 206. Classifier training server device(s) 208 may then select a set of queries from such stored query logs to use as training data in training the classifier. Moreover, the trained classifier may then be stored in a database, and from there made available to search server device(s) 206 for use in online, dynamic query reformulation.

Each of the one or more of the server devices depicted in FIG. 2 may include multiple computing devices arranged in a cluster, server farm, or other grouping to share workload. Such groups of servers may be load balanced or otherwise managed to provide more efficient operations. Moreover, although various computing devices of environment 200 are described as clients or servers, each device may operate in either capacity to perform operations related to various embodiments. Thus, the description of a device as client or server is provided for illustrative purposes, and does not limit the scope of activities that may be performed by any particular device.

### Illustrative Client Device Architecture

FIG. 3 depicts a block diagram for an example computer system architecture for web user client device(s) 204 and/or other client devices, in accordance with various embodiments. As shown, client device 300 includes processing unit 302. Processing unit 302 may encompass multiple processing units, and may be implemented as hardware, software, or some combination thereof. Processing unit 302 may include one or more processors. As used herein, processor refers to a hardware component. Processing unit 302 may include computer-executable, processor-executable, and/or machine-executable instructions written in any suitable programming language to perform various functions described herein. In some embodiments, processing unit 302 may further include one or more graphics processing units (GPUs).

Client device 300 further includes a system memory 304, which may include volatile memory such as random access memory (RAM), static random access memory (SRAM), dynamic random access memory (DRAM), and the like. System memory 304 may also include non-volatile memory such as read only memory (ROM), flash memory, and the like. System memory 304 may also include cache memory. As shown, system memory 304 includes one or more operating systems 306, program data 308, and one or more program modules 310, including programs, applications, and/or processes, that are loadable and executable by processing unit 302. Store program data 308 may be generated and/or employed by program modules 310 and/or operating system 306 during their execution. Program modules 310 include a browser application 312 (e.g. web browser) that allows a user to access web content and services, such as a web search engine or other search service available online. Program modules 310 may further include other programs 314.

As shown in FIG. 3, client device 300 may also include removable storage 316 and/or non-removable storage 318, including but not limited to magnetic disk storage, optical disk storage, tape storage, and the like. Disk drives and associated computer-readable media may provide non-volatile storage of computer readable instructions, data structures, program modules, and other data for operation of client device 300.

In general, computer-readable media includes computer storage media and communications media.

Computer storage media includes volatile and non-volatile, removable and non-removable media implemented in any method or technology for storage of information such as computer readable instructions, data structure, program modules, and other data. Computer storage media includes, but is not limited to, RAM, ROM, erasable programmable read-only memory (EEPROM), SRAM, DRAM, flash memory or other memory technology, compact disc read-only memory (CD-ROM), digital versatile disks (DVDs) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave or other transmission mechanism. As defined herein, computer storage media does not include communication media.

Client device 300 may include input device(s) 320, including but not limited to a keyboard, a mouse, a pen, a voice input device, a touch input device, and the like. Client device 300 may further include output device(s) 322 including but not limited to a display, a printer, audio speakers, and the like. Client device 300 may further include communications connection(s) 324 that allow client device 300 to communicate with other computing devices 326, including server devices, databases, or other computing devices available over network(s) 202.

### Illustrative Server Device Architecture

FIG. 4 depicts a block diagram for an example computer system architecture for various server devices depicted in FIG. 2. As shown, computing device 400 includes processing unit 402. Processing unit 402 may encompass multiple processing units, and may be implemented as hardware, software, or some combination thereof. Processing unit 402 may include one or more processors. As used herein, processor refers to a hardware component. Processing unit 402 may include computer-executable, processor-executable, and/or machine-executable instructions written in any suitable programming language to perform various functions described herein. In some embodiments, processing unit 402 may further include one or more GPUs.

Computing device 400 further includes a system memory 404, which may include volatile memory such as random access memory (RAM), static random access memory (SRAM), dynamic random access memory (DRAM), and the like. System memory 404 may further include non-volatile memory such as read only memory (ROM), flash memory, and the like. System memory 404 may also include cache memory. As shown, system memory 404 includes one or more operating systems 406, and one or more executable components 410, including components, programs, applications, and/or processes, that are loadable and executable by processing unit 402. System memory 404 may further store program/component data 408 that is generated and/or employed by executable components 410 and/or operating system 406 during their execution.

Executable components 410 include one or more of various components to implement functionality described herein, on one or more of the servers depicted in FIG. 2. For example, executable components 410 may include a search engine 412, operable to receive search queries from users and perform web searches based on those queries. Search engine 412 may further include a user interface that allows the user to input the query and view search results, such as the user interface depicted in FIG. 1. Executable components 410 may also include query processing component 414, which may be configured to perform various tasks related to query reformulation as described herein.

In some embodiments, executable components 410 may include a classifier training component 416. This component may be present, for example, where computing device 400 is one of the classifier training server device(s) 208. Classifier training component 416 may be configured to perform various tasks related to the offline training of the classifier, as described herein. Executable components 410 may further include other components 418.

As shown in FIG. 4, computing device 400 may also include removable storage 420 and/or non-removable storage 422, including but not limited to magnetic disk storage, optical disk storage, tape storage, and the like. Disk drives and associated computer-readable media may provide non-volatile storage of computer readable instructions, data structures, program modules, and other data for operation of computing device 400.

In general, computer-readable media includes computer storage media and communications media.

Computer storage media includes volatile and non-volatile, removable and non-removable media implemented in any method or technology for storage of information such as computer readable instructions, data structure, program modules, and other data. Computer storage media includes, but is not limited to, RAM, ROM, erasable programmable read-only memory (EEPROM), SRAM, DRAM, flash memory or other memory technology, compact disc read-only memory (CD-ROM), digital versatile disks (DVDs) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave or other transmission mechanism. As defined herein, computer storage media does not include communication media.

Computing device 400 may include input device(s) 424, including but not limited to a keyboard, a mouse, a pen, a voice input device, a touch input device, and the like. Computing device 400 may further include output device(s) 426 including but not limited to a display, a printer, audio speakers, and the like. Computing device 400 may further include communications connection(s) 428 that allow computing device 400 to communicate with other computing devices 430, including client devices, server devices, databases, or other computing devices available over network(s) 202.

### Illustrative Processes

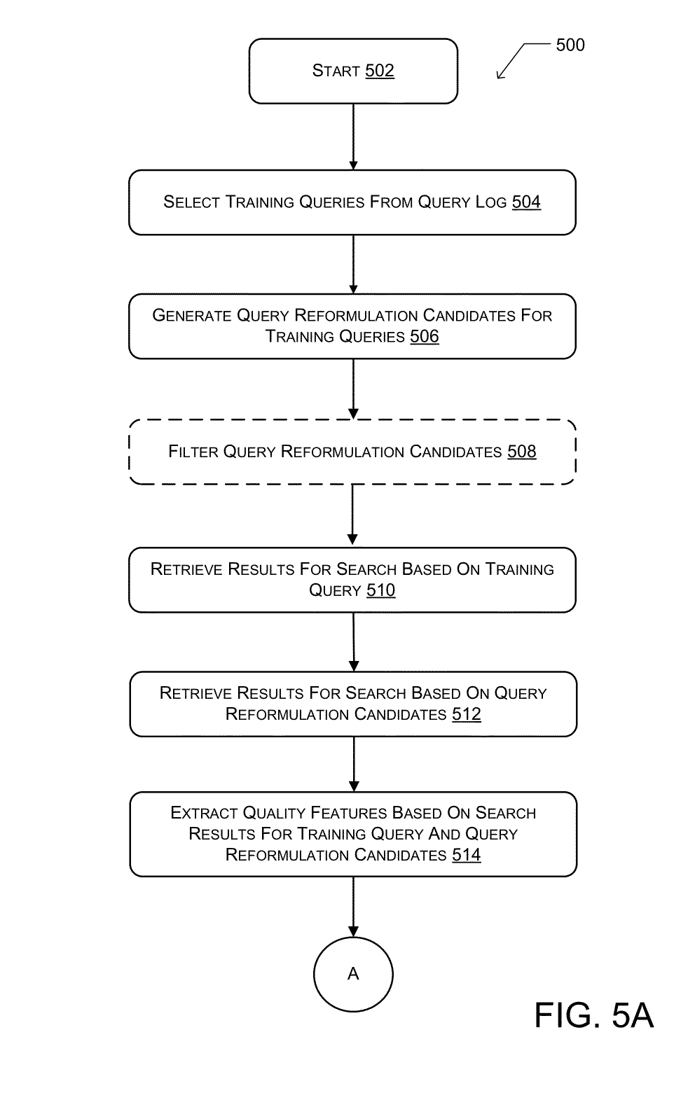

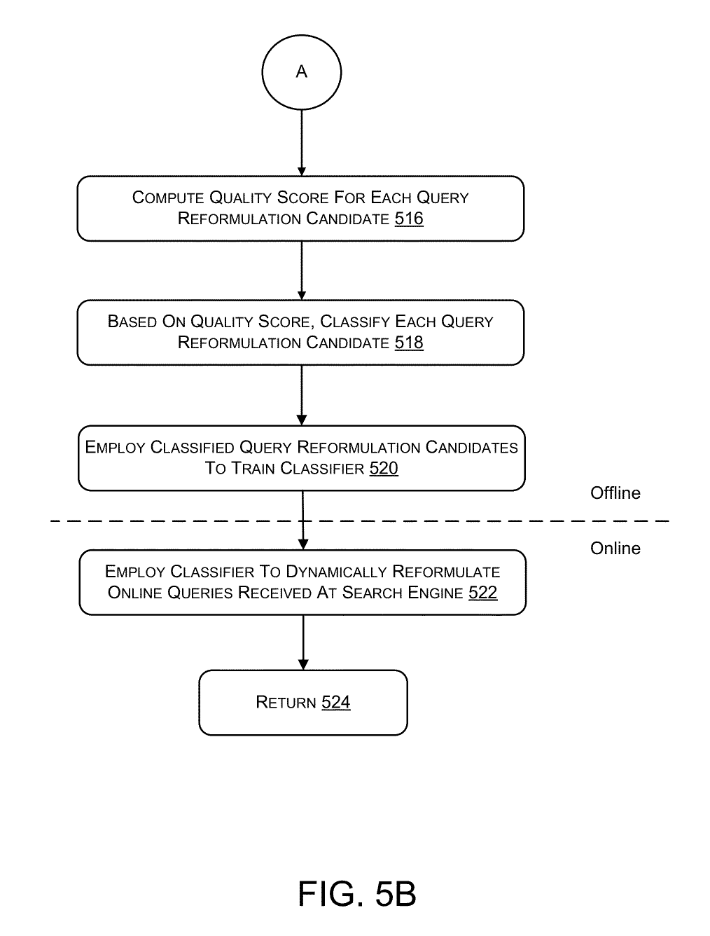

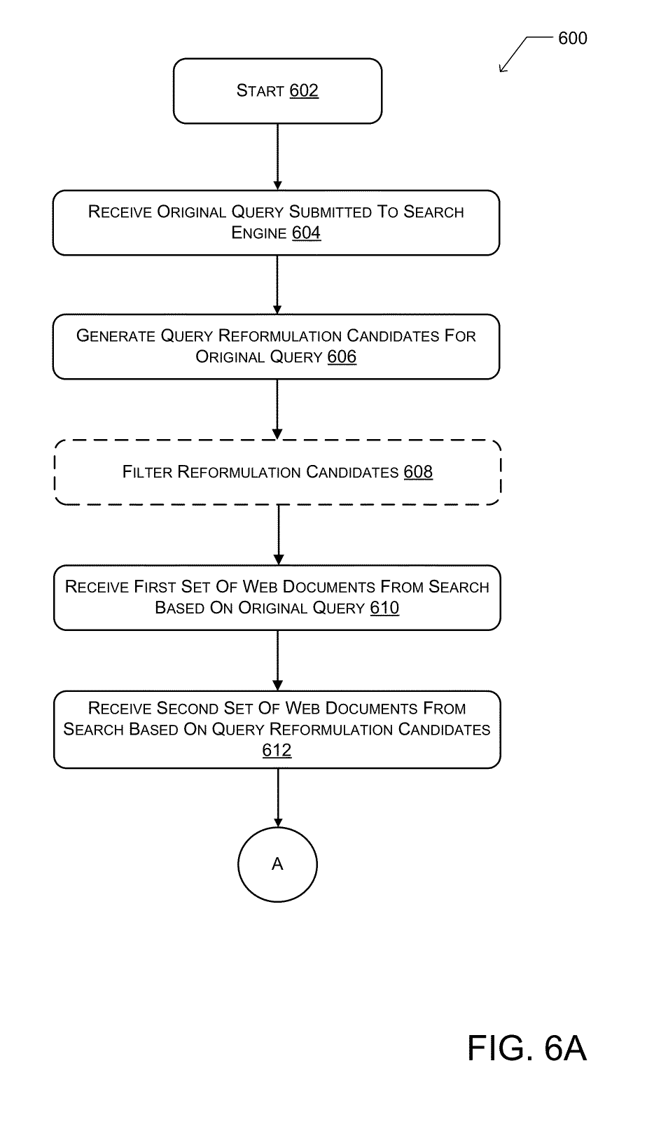

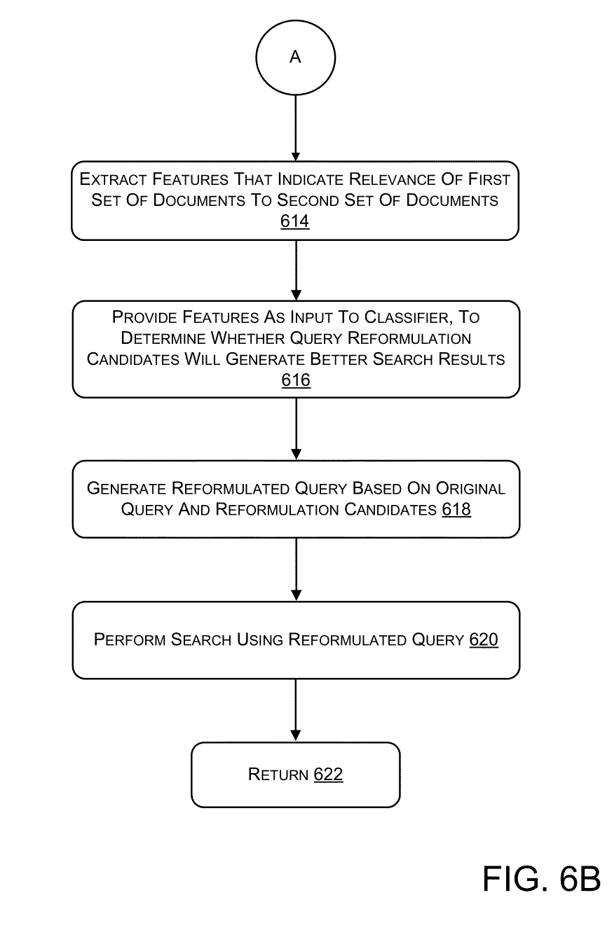

FIGS. 5A, 5B, 6A, and 6B depict flowcharts showing example processes in accordance with various embodiments. The operations of these processes are illustrated in individual blocks and summarized with reference to those blocks. The processes are illustrated as logical flow graphs, each operation of which may represent a set of operations that can be implemented in hardware, software, or a combination thereof. In the context of software, the operations represent computer-executable instructions stored on one or more computer storage media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be combined in any order and/or in parallel to implement the process.

FIGS. 5A and 5B depict an example process 500 for training a classifier for use in post-execution query reformulation, according to one or more embodiments. In some embodiments, process 500 may execute on classifier training server device(s) 208. As shown in FIG. 5A, after a start block 502 process 500 proceeds to select a set of training queries at block 504. In some embodiments, training queries may be mined or otherwise selected from query logs of past user search queries that have been archived or otherwise stored. This selection may be random, based on age of queries, or through some other method.

After the training queries have been selected, a set of one or more query reformulation candidates may be generated for each training query at block 506. In some embodiments, a reformulation candidate is a triple that includes the original (e.g. un-reformulated or raw) query, a term from the query, and a suitable substitute term for the term. This reformulation candidate may be represented mathematically as <q, tᵢ, t′ᵢ>, where q represents the query, tᵢ represents a term to be replaced, and t′ᵢ represents the replacement term. Various methods may be used to generate reformulation candidates. For example, embodiments may employ a stemming algorithm to determine reformulation candidates based on the stem or root of the term (e.g. “happiness” as a substitute term for “happy”). In some embodiments, query log data may be mined to determine substitute terms based on comparing queries to result URLs, and/or comparing multiple queries within a particular session. Moreover, substitute terms may be determined through examination of external language corpuses such as WordNet® or Wikipedia®.

In some embodiments, two different types of queries may be generated to test whether a particular reformulation candidate produces improved results. These two types are a replacement type of query, and a combination type of query. Given a query q=[t₁, t₂, . . . , tₙ], and a query reformulation candidate <q, tᵢ, t′ᵢ>, a replacement query qᵣₑₚ and combination query qₒᵣ can be represented mathematically as:

gᵣₑₚ=[t₁, t₂], . . . , t′ᵢ, . . . , tₘ] and

qₒᵣ=[t₁, t₂, . . . , (tᵢ OR t′ᵢ), . . . tₙ].

In some embodiments, query reformulation candidates may be filtered prior to further processing, to make the training process more efficient. Such filtering may operate to remove reformulation candidates that are irrelevant and/or redundant. For example, the word “gate” is a reasonable substitute term for the word “gates” generally, but for the query “Bill Gates” the word “gate” would not be an effective substitute. The filtering step operates to remove such candidates.

Proceeding to block 510, a search is performed based on each un-reformulated training query, and one or more resulting web documents are retrieved based on the search. At block 512, a search is performed based on each query reformulation candidate for the training query, resulting in another set of web documents for each reformulation candidate. In some embodiments, the resulting web documents will be returned from a search engine as a list of Uniform Resource Locators (URLs). In some embodiments, the results list will be ranked such that those documents deemed more relevant by the search engine are listed higher.

At block 514, one or more quality features are extracted based on the results of the searches performed at blocks 510 and 512. Such quality features generally indicate the relevance of two sets of search results from the un-reformulated training query and the query reformulation candidate, and thus provide an indication of the quality of the reformulation candidate as compared to the un-reformulated training query. Quality features may include two types of features: ranking features and topic drift features.

Ranking features give evidence that the reformulated query provides improved results such that more relevant documents are ranked higher in the search results. For example, a query “lake city ga” has a reformulation candidate of (“lake city ga”, ga, georgia) (i.e., “georgia” is a substitute term for “ga”). If this is a beneficial reformulation candidate, then the more relevant documents will appear higher in search results based on the query “‘lake city’ AND (ga OR georgia)” then they would in search results based on the un-reformulated query “lake city ga”.

In some embodiments, ranking features include one or more of the following features:
BM25: This feature measures the relevance of a search result web document compared to the terms in the search query, based on a determination that query words appear in the whole document more frequently than they do in a global language corpus.
Number Of Matches—Body: This feature measures the number of matches of all query terms in the document body.
Number Of Matches—URL: This features measures the number of matches of all query terms in the URL of the document.
Number Of Matches—Anchor: This feature measures the number of matches of all query terms in the Anchor text of the document.
Number Of Matches—Title: This feature measures the number of matches of all query terms in the Title of the document.
Ranking Score: This score is a combination of all the other features.

The above ranking features, including the ranking score, are for a particular document in a results list. To measure a collective quality of one or more documents (e.g. a particular number of the top ranked documents in the results list), the ranking features can be summarized as a mathematical combination. In some embodiments, this summary of ranking features is calculated using the following formula:

$$F ( ranking feature ) = {\sum }_{i = 1}^{n} ( ( n - i + 1 ) * f ( {d}_{i} ) )$$

where i is the ranking position of the document. For every ranking feature, f(dᵢ) is the value of the ranking feature for a document which is ranked in the ith position in a results list. Ranking features may be extracted based on the results of a search on an un-reformulated query as well as the results of a search based on a reformulated query.

In some embodiments, two additional ratio-based ranking features are calculated: Fₒᵣ/F_{row} and Fᵣₑₚ/F_{row}, where F_{row}, Fᵣₑₚ, and Fₒᵣ refer respectively to a feature of q, qᵣₑₚ, and qₒᵣ. For each of these features, a ratio of greater than one indicates that the feature value increases in comparison to the corresponding feature calculated for the un-reformulated query q.

Topic drift features give evidence that the reformulation is causing topic drift relative to the un-reformulated query. Example embodiments employ two topic drift features: term exchangeability and topic match.

The term exchangeability feature measures the topic similarity between a set of result documents from the un-reformulated query and a set of result documents from the reformulation candidate query, by measuring the exchangeability between the original term and the substitute term of the query reformulation candidate. Generally, the more exchangeable the original and substitute terms, the less topic drift is present in the two document results sets.

Term exchangeability is determined by examining co-occurrences of the term and the substitute term in the sets of results documents. Co-occurrence of the two terms are examined in the following document areas:
Body: Both the term and the substitute term appear in the body text of a document.
Title: Both terms appear in the title text of the document.
BodyAnchor: One term appears in the document's body, while the other term appears in one of the document's anchor texts.
BodyTitle: One term appears in the document's body, while the other term appears in the document's title.
TitleAnchor: One term appears in the document's title, while the other term appears in the document's anchor text.
SameAnchor: One of the document's anchor texts contains both terms.
DiffAnchor: One term is contained in one anchor text of the document, while the other term is contained in a different anchor text of the document.

In some embodiments, each of the co-occurrence measures listed above may be normalized to binary form, such that each counts for either 0 or 1 based on whether each condition is true at least once within the document.

The second topic drift type of feature is the topic match. This feature measures whether the two queries (e.g. based on the un-reformulated training query and the reformulation candidate) have semantic similarity in the topics of their result document sets. For each document set, a set of topics is calculated by determining those words that occur at a higher frequency in the results documents compared to the frequency of that word in the global document corpus. Effectively, this is a measure of the relevance of the topic word to the document. If the two queries have similar topic word lists, then a determination is made that they have semantic similarity.

In some embodiments the set of features (i.e. ranking features and topic drift features) is formed into a feature vector for each reformulation candidate. This feature vector is used, along with a quality classification based on a quality score, for training the classifier.

As shown in FIG. 5B, process 500 continues to block 516 where a quality score is computed for each query reformulation candidate. After retrieving search results for the reformulation candidates (e.g., as in block 512), each document in the search results is labeled based on a level of closeness of the result document to the query that produced it. Such labeling may occur at any level of granularity. For example, in some embodiments the documents are labeled as one of the following: perfect, excellent, good, fair, bad, and detrimental. In some embodiments, this labeling may be a manual process, based on a subjective judgment by a human labeler who labels the documents based on his/her knowledge and experience. In some cases, additional guidelines may be provided to the labelers, for example to provide greater uniformity between labelers.

Based on the labeling, a discounted cumulative gain (DCG) score is computed for each query, including un-reformulated queries and reformulation candidate queries. Computation of the DCG score may include assignment of a numerical value to the labels. For example, in some embodiments a label of perfect is assigned a value 31, excellent is assigned 15, good is assigned 7, fair is assigned 3, bad is assigned 0, and detrimental is also assigned 0. This value is then weighted by the position of the document in the ranked list of results (e.g., the top ranked document value is divided by 1, the second ranked document value is divided to 2, and so forth). The resulting weighted values are then added together to determine DCG. Then, a normalized DCG score (nDCG) is calculated for each result set. In some embodiments, nDCG is determined by dividing each DCG score in a result set by an ideal DCG score. The ideal DCG score is computed based on an ideal result list, which is produced by sorting all the labeled documents by their label values in a descending order.

In this way, a quality score (such as the above-discussed nDCG score) is determined for the un-reformulated query (e.g. the raw training query) and for each reformulation candidate at block 516. At block 518, a difference between the scores is calculated, and this score difference is used to classify each reformulation candidate as one of three classes: positive, negative, or neutral. If the score difference is greater than zero, i.e., where the reformulation candidate has a higher score than the un-reformulated query, then the reformulation candidate is classified as positive. If the score difference is less than zero, the reformulation candidate is classified as negative. If the score difference is zero or within a certain threshold distance from zero, the reformulation candidate is classified as neutral.

At block 520, the feature vector and classification for each reformulation candidate is used to train the classifier. In some embodiments, this training proceeds through supervised machine learning (e.g. using a decision tree or SVM method). As described herein, training the classifier may be accomplished in an offline process. This process may run periodically (e.g., weekly or monthly as a batch process), or more frequently. In some embodiments, the same set of training data may be using for each instance of training the classifier, while in other embodiments the set of training data may be altered. In some embodiments, each instance of training the classifier may start from scratch and create a new classifier, while in some embodiments training the classifier may be an iterative process that proceeds using the previously trained classifier as a starting point.

At block, 522, the classifier is employed during online search query processing to dynamically reformulate search queries submitted by users. This online query reformulation process is described further herein with regard to FIGS. 6A and 6B. At block 524, process 500 returns.

FIGS. 6A and 6B depict an example process 600 for employing a classifier for query reformulation of online queries, according to embodiments. In some embodiments, process 600 executes on one or more of search server device(s) 206. As shown in FIG. 6A, after a start block 602, process 600 proceeds to block 604 where one or more original queries are received. Such queries may be received by a search engine, and may be submitted by users seeking to search the web for documents relevant to their query. User queries may comprise a combination of one or more terms and/or logical operators, as described above with regard to FIG. 1.

At block 606, one or more query reformulation candidates may be generated for the original query. Query reformulation candidates may be generated as described above with regard to FIG. 5A. In some embodiments, a smaller number of query reformulation candidates are employed in the online mode than are employed in the offline classifier training process, to allow for faster online processing of the user's original query. In some embodiments, the query reformulation candidates are filtered at block 608. Such filtering may be performed in a similar way as described above with regard to FIG. 5A.

At block 610, a first set of web documents may be received, resulting from a search based on the user's original query. At block 612, a search is performed based on each query reformulation candidate, resulting in a second set of web documents for each reformulation candidate. The resulting web documents may be returned from a search engine as a list of URLs. In some embodiments, the first and/or second set of web documents are ranked such that those documents deemed more relevant by the search engine are listed higher.

With reference to FIG. 6B, at block 614, one or more quality features are extracted based on the first and second sets of documents resulting from the searches performed at blocks 610 and 612. Such quality features generally indicate the relevance of the two sets of search results, and provide an indication of the quality of each reformulation candidate as compared to the original query. These quality features may include ranking features and topic drift features, as described above.

At block 616, the extracted features are provided as input to the classifier, which then uses the input features to classify each query reformulation candidate. Such classification may determine whether each query reformulation candidate is likely to result in an improved set of search results. In some embodiments, the classifier is a three-class classifier that classifies each query reformulation candidate into one of the three categories described above: positive, negative, and neutral.

At block 618, a reformulated query is generated based on the results of the classification of query reformulation candidates. Positive-classified and/or neutral-classified query reformulation candidates may be selected to generate the reformulated query. In some embodiments, negative-classified query reformulation candidates are not selected to generate the reformulated query.

In some embodiments, the reformulated query is generated by adding each selected reformulation candidate to the original query. If a query is a set of terms represented mathematically as q={t₁ . . . tₙ}, and a reformulation candidate is represented by a triple (q, t, t′), the reformulated query qᵣ may be represented by: qᵣ={t₁ . . . (t OR t′) . . . tₙ}. For example, a user enters an original query of “used cars”. A possible reformulation candidate (“used cars”, “cars”, “automobiles”) (i.e., the candidate in which the term “cars” is replaced by the term “automobiles”) is determined by the classifier to be positive or neutral. The reformulated query including this candidate is “used (cars OR automobiles)”.

At block 620, a search is performed by sending the reformulated query to the search engine, and results from the search are provided to the user who submitted the original query. In some embodiments, the process of query reformulation is transparent to the user, such that the user is unaware that any reformulation has taken place. For example, using the example query above, if the user enters a query “used cars”, the user will be presented with a list of web documents resulting from a search on “used (cars OR automobiles)”. In this case, the user will not be aware that a reformulated search query was used to generate the results. However, in an alternate implementation, the user may be notified that a reformulated query was used. At block 622, process 600 returns.

### CONCLUSION

As described herein, the query reformulation process provides a type of heuristic—a way of predicting whether a particular reformulation candidate can improve search relevance based on the search results of the query reformulation candidate. Although the techniques have been described in language specific to structural features and/or methodological acts, it is to be understood that the appended claims are not necessarily limited to the specific features or acts described. Rather, the specific features and acts are disclosed as example forms of implementing such techniques.

1. A computer-implemented method for search query reformulation, comprising:
generating a query reformulation candidate for an original query;
receiving a first set of documents in response to a search based on the original query;
receiving a second of documents in response to a search based on the query reformulation candidate;
extracting one or more features that indicate a relevance of the first set of documents to the second set of documents; and
providing the one or more features to a classifier, wherein the classifier determines whether the query reformulation candidate will generate more relevant search results than the original query.

2. The method of claim 1, wherein the original query is submitted to a search engine online, and wherein the classifier is trained offline.

3. The method of claim 1, wherein the classifier is a three-class classifier that classifies the query reformulation candidate into one of a set of categories that includes a positive category, a negative category, and a neutral category.

4. The method of claim 1, wherein the classifier is trained offline using a supervised learning method.

5. The method of claim 4, wherein the supervised learning method is at least one of a decision tree method or a support vector machine method.

6. The method of claim 1, further comprising:
generating a reformulated query that is a combination of the original query and the query reformulation candidate, based on the determination that the query reformulation candidate will generate more relevant search results; and
searching using the reformulated query.

7. The method of claim 1, wherein the query reformulation candidate includes a term of the original query and a possible substitute term.

8. The method of claim 1, wherein the one or more features include at least one ranking feature and at least one topic drift feature.

9. A server device, comprising:
at least one processor; and
a query processing component, executable by the at least one processor and configured to perform operations including:
generating a query reformulation candidate for an original query submitted to a search engine;
employing the search engine to execute a search based on the original query;
receiving a first set of web documents in response to the search based on the original query;
employing the search engine to execute a search based on the query reformulation candidate;
receiving a second set of documents in response to the search based on the query reformulation candidate;
extracting one or more features that indicate a relevance of the first set of web documents to the second set of web documents; and
providing the one or more features as input to a multi-class classifier model, wherein the multi-class classifier model determines whether
the query reformulation candidate will generate improved search results compared to the original query.

10. The server device of claim 9, wherein the operations further include filtering one or more query reformulation candidates prior to employing the search engine to execute the search based on the query reformulation candidate.

11. The server device of claim 10, wherein the filtering includes removing at least one query reformulation candidate that is irrelevant or redundant.

12. The server device of claim 9, wherein the multi-class classifier model is a three-class classifier model that classifies the query reformulation candidate into one of a set of categories that includes a positive category, a negative category, and a neutral category.

13. The server device of claim 12, wherein the positive category indicates an improved search result, wherein the negative category indicates a worse search result, and wherein the neutral category indicates a substantially similar search result compared to searching based on the original query.

14. The server device of claim 9, wherein the search engine receives the original query in an online mode, and wherein the multi-class classifier model is trained in an offline mode.

15. The server device of claim 9, wherein the one or more features include at least one ranking feature and at least one topic drift feature.

16. A computer-implemented method for search query reformulation, comprising:
generating at least one query reformulation candidate for a training query;
retrieving one or more candidate search result documents in response to a search based on the at least one query reformulation candidate;
retrieving one or more original search result documents in response to a search based on the training query;
extracting one or more quality features based on the one or more candidate search result documents and on the one or more original search result documents;
computing a quality score for each of the at least one query reformulation candidate, wherein the quality score indicates a relative quality of the at least one query reformulation candidate compared to the training query;
based on the computed quality score, classifying each of the at least one query reformulation candidate into one of a set of categories that includes a positive category, a negative category, and a neutral category;
employing the classified at least one query reformulation candidate to train a classifier, using a supervised learning method; and
employing the classifier to dynamically reformulate one or more online queries received at a search engine.

17. The method of claim 16, wherein each of the at least one query reformulation candidate includes a term from the training query and a possible substitute term for the term.

18. The method of claim 16, wherein the one or more quality features include at least one ranking feature and at least one topic drift feature.

19. The method of claim 16, further comprising randomly selecting the training query from a query log of previous search queries.

20. The method of claim 16, further comprising filtering the at least one query reformulation candidate prior to retrieving the one or more candidate search result documents.
